(19) United States
(12) Patent Application Publication
(10) Pub. No.: US 2022/0277271 A1
(43) Pub. Date: Sep. 1, 2022

(54) A CAREER MENTORING SYSTEM AND METHOD

(71) Applicant: INTERCELL TECHNOLOGIES PVT. LTD., Gurugram (IN)

(72) Inventor: Arunabh VARMA, New Delhi (IN)

(73) Assignee: INTERCELL TECHNOLOGIES PVT. LTD., Gurugram (IN)

(21) Appl. No.: 17/631,627

(22) PCT Filed: Jul. 30, 2020
(86) PCT No.: PCT/IN2020/050673

§ 371 Date: Jan. 31, 2022

(30) Foreign Application Priority Data
Aug. 1, 2019 (IN) 201911031212

(51) Int. Cl. G06Q 10/10

(52) U.S. Cl. CPC G06Q 10/105

(57) ABSTRACT

The present invention relates to a career mentoring system (100). The career mentoring system (100) includes a central server computer (102), a mentor device (108) and a mentee device (118). The central server computer (102) further includes a central database storage unit (104) and a central processing unit (106). The central processing unit (106) executes computer readable instructions for real time mentor-mentee interaction. The mentor device (108) includes a mentor device processing unit (110), a mentor database storage unit (112), a mentor input unit (114) and a mentor interaction unit (116). The mentee device (118) includes a mentee device processing unit (120), a mentee database storage unit (122), a mentee input unit (124) and a mentee interaction unit (126). The central server computer (102) executes computer readable instructions for the career mentoring by communicating with the mentor device (108) and the mentee device (118).

### FIELD OF THE INVENTION

The present invention relates to a career mentoring system, more specifically the present invention relates to a career mentoring system with real time mentor-mentee interaction.

### BACKGROUND OF THE INVENTION

As per research data, global youth unemployment rate is rising every year. India is producing 20 million graduates every year and majority of them are not getting job as per their qualifications. Young graduates face significant challenges in finding decent jobs and the main reason is not lack education or degree, but it is lack of mentoring, guidance and knowledge of career options available. A majority of them find it difficult to choose the right career option after graduation. It is important for students and professionals to get proper career counseling by a mentor. Traditional mentorship needs physical presence of qualified mentor. Thus, only a handful of students may benefit from mentoring guidance of an expert. In this era of digitalization, it is important to provide the bridge of career counseling to connect Mentees with Mentors on virtual platform which eradicates all logistics issues for Students and Professionals.

US2014074740 (A1) discloses Methods and systems for providing career advice to a college student are disclosed. In some embodiments, the method may include receiving one or more user vocational interests of the college student and generating a user interest vector based on the one or more user vocational interests. The method may include receiving vocational interests of college affiliates, data regarding events, or data regarding job opportunities. The method may include assigning resource vocational interests to college affiliates, events, or job opportunities. The method may generate resource interest vectors associated with college affiliates, events, or job opportunities wherein each resource interest vector is based on the respective resource vocational interests. The method may compute one or more distances between the user interest vector and one or more resource interest vectors. The method may generate one or more recommendations of advice connections, events, or job opportunities based on the computed distances.

The existing inventions disclose the systems and methods for career advice. Though existing inventions provide solutions but those are not providing real time interaction between industry expert mentors and mentees. The present invention provides a system and method to connect industry expert mentors with mentees on real time basis hence there is need of the present invention.

OBJECTIVE OF THE INVENTION

The main objective of the present invention is to provide a career mentoring system with real time mentor-mentee interaction.

The principal objective of the present invention is to one-on-one virtual mentee-mentor interaction session.

Another objective of the present invention is to select mentors across different career fields and sub career fields by mentee for mentoring session.

Yet another objective of the present invention is to select mentors across the globe by the mentee.

Yet another objective of the present invention is to allow mentee to read mentors profile and book a real time mentoring session.

Yet another objective of the present invention is to provide unlimited mentoring sessions for mentees and mentors.

Yet another objective of the present invention is to allow mentees and mentors to take quarterly and annual subscriptions for mentoring session.

Yet another objective of the present invention is to allow mentees to connect multiple mentors.

Further objectives, advantages and features of the present invention will become apparent from the detailed description provided herein below, in which various embodiments of the disclosed invention are illustrated by way of example and appropriate reference to accompanying drawings.

### SUMMARY OF THE PRESENT INVENTION

The present invention relates to a career mentoring system. The present invention includes a central server computer, a mentor device and a mentee device. The central server computer further includes a central database storage unit and a central processing unit. The central database storage unit stores mentor's and mentee's data. The central processing unit executes computer readable instructions for real time mentor-mentee interaction. The mentor device includes a mentor device processing unit, a mentor database storage unit, a mentor input unit and a mentor interaction unit. The mentee device includes a mentee device processing unit, a mentee database storage unit, a mentee input unit and a mentee interaction unit. The central processing unit of central server computer executes computer readable instructions of the career mentoring system by communicating with the mentor device and the mentee device. The mentor device and the mentee device are in two-way communication with the central server computer through internet. The mentor device processing unit and the mentee device processing unit execute computer readable instructions for mentor's and mentee's registration respectively. All data of mentor and mentee is stored in the central database storage unit after registration The mentor input unit and the mentee input unit is used to input data and instruction from mentor and mentee to the mentor device and the mentee device respectively for registration and interaction between mentor and mentee.

An advantage of the present invention is that the present invention provides a career mentoring system with real time mentor-mentee interaction.

Another advantage of the present invention is that the present invention provides one-on-one virtual mentee-mentor interaction session.

Yet another advantage of the present invention is that the present invention allows selecting mentors across different career fields and career sub fields by mentee for mentoring session.

Yet another advantage of the present invention is that the present invention allows mentees to select mentors across the globe.

Yet another advantage of the present invention is that the present invention allows mentee to read mentors profile and book a real time mentoring session.

Yet another advantage of the present invention is that the present invention allows mentees and mentors to take quarterly and annual subscriptions for mentoring session.

Yet another advantage of the present invention is that the present invention allows mentees to connect multiple mentors.

Further objectives, advantages and features of the present invention will become apparent from the detailed description provided herein below, in which various embodiments of the disclosed invention are illustrated by way of example and appropriate reference to accompanying drawings.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates the line diagram for the system of the present invention.

FIG. 2 illustrates the flow chart of a method for registration of the mentee.

FIG. 3 illustrates the flow chart of a method for registration of the mentor.

FIG. 4 illustrates the flow chart of a method for validation of the mentor.

FIG. 5 illustrates the flow chart of a method of mentoring for the mentee.

FIG. 6 illustrates the flow chart of a method of mentoring by the mentor.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definition

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

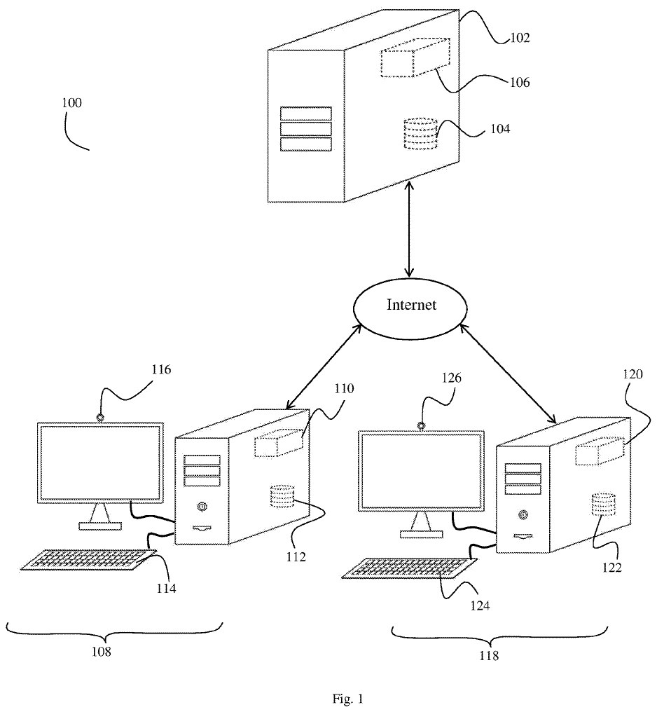

FIG. 1. Illustrates a line diagram of a career mentoring system (100). The career mentoring system (100) includes a central server computer (102), a mentor device (108) and a mentee device (118). The central server computer (102) further includes a central database storage unit (104) and a central processing unit (106). The central database storage unit (104) stores mentor's and mentee's data. The central processing unit (106) executes computer readable instructions for real time mentor-mentee interaction. The mentor device (108) includes a mentor device processing unit (110), a mentor database storage unit (112), a mentor input unit (114) and a mentor interaction unit (116). The mentee device (118) includes a mentee device processing unit (120), a mentee database storage unit (122), a mentee input unit (124) and a mentee interaction unit (126). The central server computer (102) executes computer readable instructions of the career mentoring system by communicating with the mentor device (108) and the mentee device (118). The mentor device (108) and the mentee device (118) are in two-way communication with the central server computer (102) through internet.

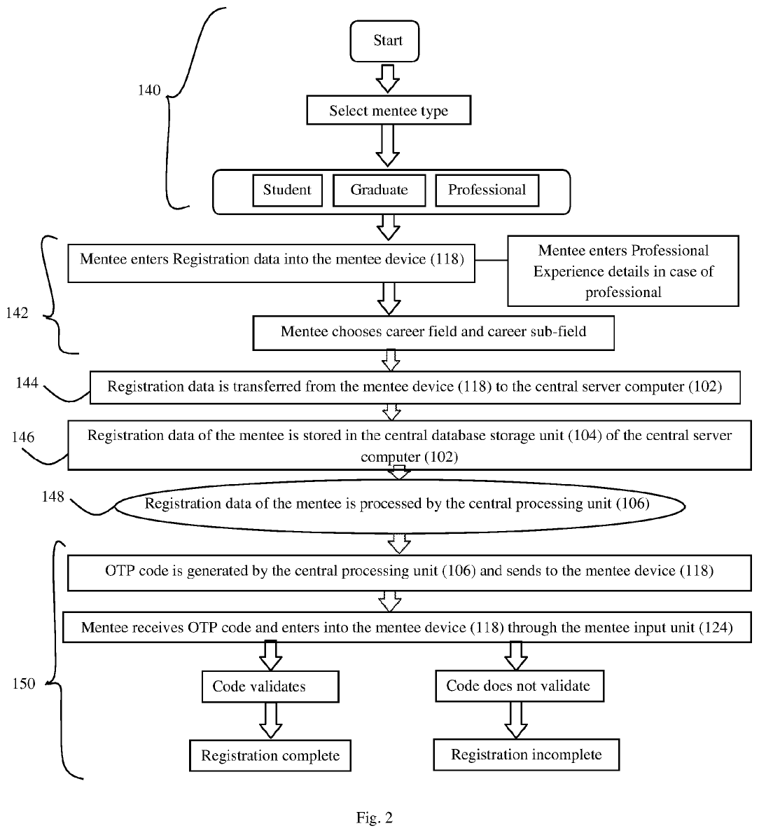

FIG. 2 illustrates the flow chart of a method for registration of the mentee in the mentee device (118) through the mentee input unit (124). In step (140), the mentee logs into the mentee device (118) and starts registration process. The mentee selects mentee type. The mentee type includes, but not limited to, student, graduate and professional. In step (142), the mentee enters registration data into the mentee device (118). The mentee enters professional experience details in case of professional mentee type by the mentee input unit (124). Further the mentee chooses career field and career sub field. In step (144), the registration data of the mentee is transferred from the mentee device (118) to the central server computer (102) through internet. In step (146), the registration data of the mentee is stored in the central database storage unit (104) of the central server computer (102). In step (148), the registration data of the mentee is processed by the central processing unit (106) for validation. In step (150), a one-time password code is generated by the central processing unit (106) and sends to the mentee device (118) for validation. The mentee device (118) receives one-time password in form of electronic message notification. The one-time password code is entered into the mentee device (118) through the mentee input unit (124) for validation. After successful one-time password code verification the registration process is completed, otherwise the registration process is uncompleted.

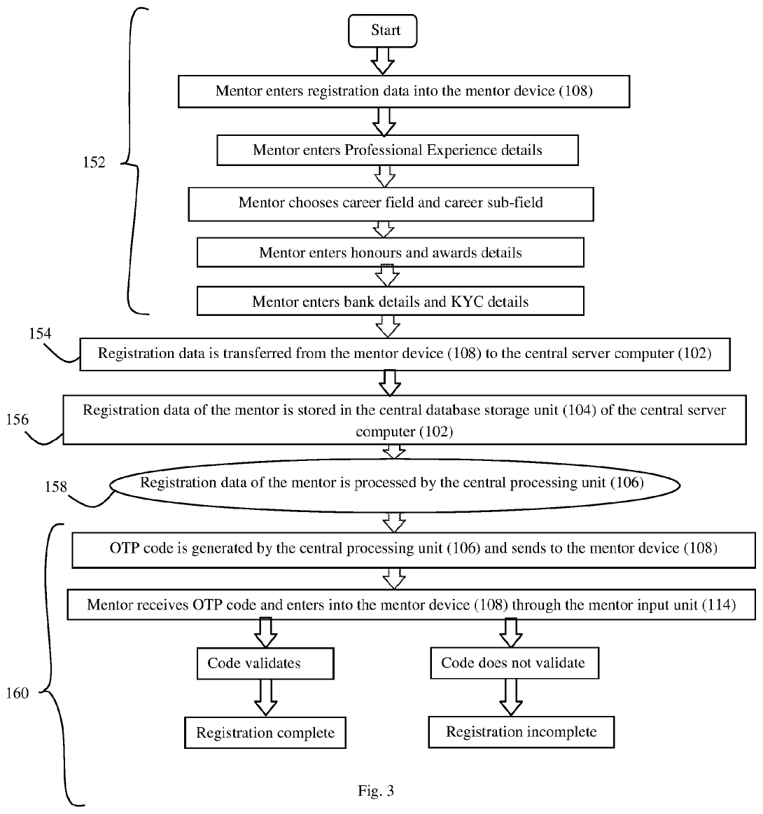

FIG. 3 illustrates the flow chart of a method for registration of the mentor in the mentor device (108) through the mentor input unit (114). In step (152), the mentor logs into the mentor device (108) and starts registration process. The mentor enters registration data into the mentor device (108). The mentor enters professional experience details and chooses career field and career sub field. Further the mentor enters honors, awards, bank details and KYC details into the mentor device (108) through the mentor input unit (114). In step (154), the registration data of the mentor is transferred from the mentor device (108) to the central server computer (102) through internet. In step (156), the registration data of the mentor is stored in central database storage unit (104). In step (158), the registration data of the mentor is processed by the central processing unit (106) for validation. In step (160), a one-time password code is generated by the central processing unit (106) and sends to the mentor device (108) for verification. The mentee device (108) receives one-time password in form of electronic message notification. The one-time password code is entered into the mentor device (108) through the mentor input unit (114) for verification. After successful one-time password code verification the registration process is completed, otherwise the registration process is uncompleted.

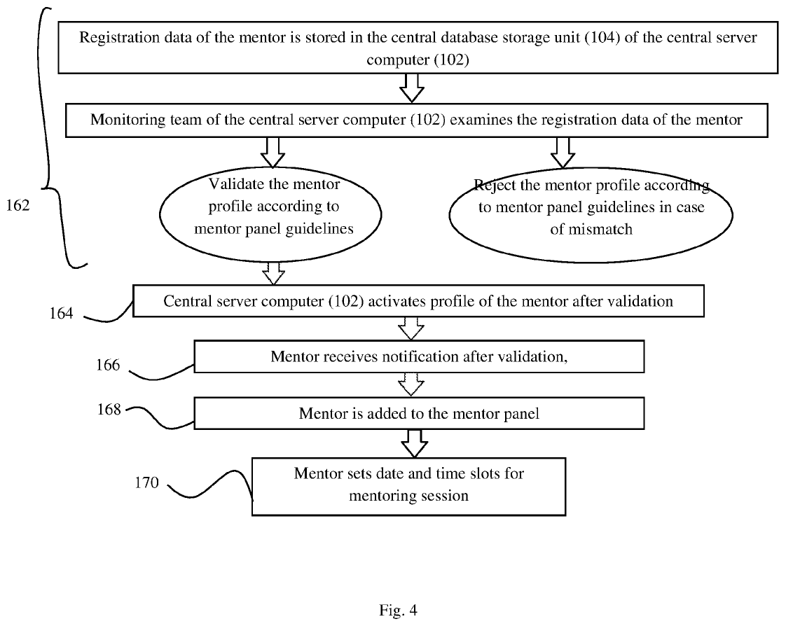

FIG. 4 illustrates the flow chart of a method for validation of the mentor. In step (162), after the registration of the mentor, a monitoring team of the central server computer (102) examines the registration data of the mentor and validates the mentor profile according to mentor panel guidelines. In case of mismatch in mentor application and mentor panel guidelines, the monitoring team of the central server computer (102) rejects the mentor application. In step (164), the central server computer (102) activates profile of the mentor after validation. In step (166), the mentor receives notification in form of electronic message notification after validation. In step (168), the mentor is added to the mentor panel. In step (170), the mentor sets date and time slots for mentoring session according to availability into the mentor device (108).

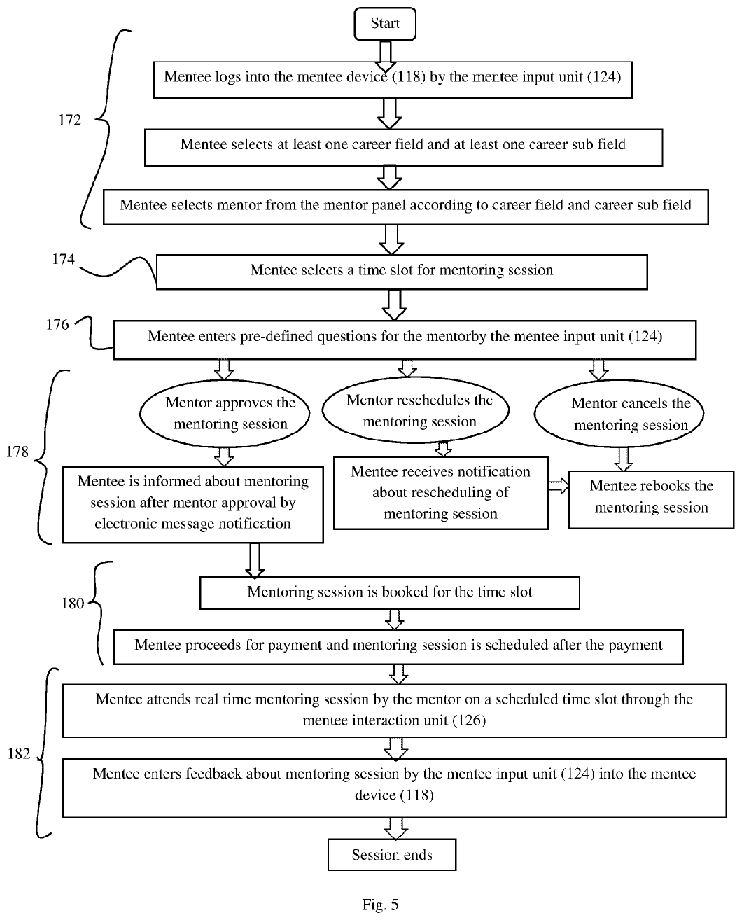

FIG. 5 illustrates the flow chart of a method of mentoring for the mentee. In step (172), the mentee logs into the mentee device (118) by the mentee input unit (124) and selects career field and career sub field. The mentee selects mentor from the mentor panel according to career field and career sub field. In step (174), the mentee selects a time slot for mentoring session for a particular mentor. In step (176), the mentee enters session expectations by the mentee input unit (124) for the mentor from the career sub field. In step (178), the mentor approves the mentoring session, otherwise the mentor reschedules the mentoring session according to availability of time slot, otherwise the mentor cancels the mentoring session and mentee needs to rebook the mentoring session. The mentee receives notifications about approval, cancellation and rescheduling of mentoring session by the electronic message notification. In step (180), the mentoring session is booked for the time slot. Further the mentee proceeds for payment and mentoring session is scheduled after the payment. In step (182), the mentee attends real time mentoring session by the mentor on a scheduled time slot through the mentee interaction unit (126). The mentee enters feedback after mentoring session by the mentee input unit (124) into the mentee device (118).

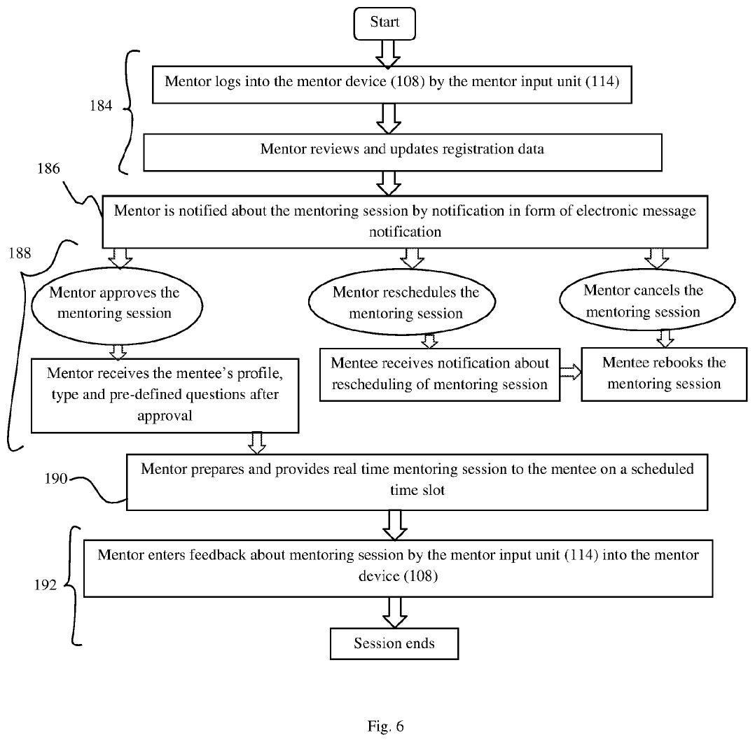

FIG. 6 illustrates the flow chart of a method of mentoring by the mentor. In step (184), the mentor logs into the mentor device (108) by the mentee input unit (114). The mentor reviews and updates registration data. In step (186), the mentor is notified about the mentoring session by notification in form of electronic message notification. In step (188), the mentor approves the mentoring session into the mentor device (108) by the mentor input unit (114), otherwise the mentor reschedules the mentoring session according to availability of time slot, otherwise the mentor cancels the mentoring session and mentee needs to rebook the mentoring session. After approval the mentor receives the mentee's profile, type and session expectations through the mentor device (108). In step (190), the mentor prepares for the mentoring session. The mentor provides real time mentoring session to the mentee on a scheduled time slot through the mentor interaction unit (116). In step (192), the mentor enters feedback about the mentoring session by the mentor input unit (114) into the mentor device (108).

The present invention relates to a career mentoring system. The present invention includes a central server computer, a mentor device and a mentee device. The central server computer further includes a central database storage unit and a central processing unit. The central database storage unit stores mentor's and mentee's data. The central processing unit executes computer readable instructions for real time mentor-mentee interaction. The mentor device includes a mentor device processing unit, a mentor database storage unit, a mentor input unit and a mentor interaction unit. It allows input of raw data to the computer for processing. The mentee device includes a mentee device processing unit, a mentee database storage unit, a mentee input unit and a mentee interaction unit. The central processing unit of the central server computer executes computer readable instructions of the career mentoring system by communicating with the mentor device and the mentee device. The mentor device and the mentee device are in two-way communication with the central server computer through internet. The mentor device processing unit and the mentee device processing unit execute computer readable instructions for mentor's and mentee's registration respectively. All data of mentor and mentee is stored in the central database storage unit after registration. The mentor input unit and the mentee input unit is used to input data and instruction from mentor and mentee to the mentor device and the mentee device respectively for registration and interaction between mentor and mentee. The mentor interaction unit and the mentee interaction unit enable real time interaction between mentor and mentee through the mentor device and the mentee device. The mentor device processing unit further executes computer readable instruction in order to help the mentor input unit and the mentor interaction unit to function and enable communication among mentor, mentee and the central server computer by using a mentor input unit and a mentor interaction unit. The mentee device processing unit further executes computer readable instruction in order to help the mentee input unit and the mentee interaction unit to function and enable communication among mentor, mentee and the central server computer by using the mentee input unit and the mentee interaction unit. The mentor database storage unit stores computer readable instruction that is being executed by mentor device processing unit and further stores data input from the mentor input unit. The mentee database storage unit stores computer readable instruction that is being executed by the mentee device processing unit and further stores data input from the mentee input unit. In an embodiment, the mentor interaction unit and the mentee interaction unit work on video mode, audio mode and text mode for real time interaction between mentor and mentee through the mentor device and the mentee device. The central server computer is enabled with artificial intelligence and improves the computer readable instructions that are being executed in the central processing unit. The career mentoring system is used to organize individual mentoring, group mentoring and virtual conferences. In an embodiment, the mentor is selected from the group consisting of industry expert, professor, experienced professional, alumni and subject matter expert. In an embodiment, the mentor device and the mentee device are selected from the group consisting of mobile phone, laptop computer, tablet device, desktop computer and other electronic communication devices.

In an embodiment, the present invention relates to a career mentoring system. The present invention includes a central server computer, one or more mentor devices and one or more mentee devices. The central server computer further includes a central database storage unit and a central processing unit. The central database storage unit stores mentor's and mentee's data. The central processing unit executes computer readable instructions for real time mentor-mentee interaction. The one or more mentor devices include a mentor device processing unit, a mentor database storage unit, a mentor input unit and a mentor interaction unit. The one or more mentee devices include a mentee device processing unit, a mentee database storage unit, a mentee input unit and a mentee interaction unit. The central processing unit of central server computer executes computer readable instructions of the career mentoring system by communicating with the one or more mentor devices and the one or more mentee devices. The one or more mentor devices and the one or more mentee devices are in two-way communication with the central server computer through internet. The mentor device processing unit and the mentee device processing unit execute computer readable instructions for mentor's and mentee's registration respectively. All data of mentor and mentee is stored in the central database storage unit after registration. The mentor input unit and the mentee input unit is used to input data and instruction from mentor and mentee to the one or more mentor devices and the one or more mentee devices respectively for registration and interaction between mentor and mentee. The mentor interaction unit and the mentee interaction unit enable real time interaction between mentor and mentee through the one or more mentor devices and the one or more mentee devices. The mentor device processing unit further executes computer readable instruction in order to help the mentor input unit and the mentor interaction unit to function and enable communication among mentor, mentee and the central server computer by using a mentor input unit and a mentor interaction unit. The mentee device processing unit further executes computer readable instruction in order to help the mentee input unit and the mentee interaction unit to function and enable communication among mentor, mentee and the central server computer by using the mentee input unit and the mentee interaction unit. The mentor database storage unit stores computer readable instruction that is being executed by mentor device processing unit and further stores data input from the mentor input unit. The mentee database storage unit stores computer readable instruction that is being executed by the mentee device processing unit and further stores data input from the mentee input unit. In an embodiment, the mentor interaction unit and the mentee interaction unit work on video mode, audio mode and text mode for real time interaction between mentor and mentee through the one or more mentor devices and the one or more mentee devices. The central server computer is enabled with artificial intelligence. The career mentoring system is used to organize individual mentoring, group mentoring and virtual conferences. In an embodiment, the mentor is selected from the group consisting of industry expert, professor, experienced professional, alumni and subject matter expert. In an embodiment, the one or more mentor devices and the one or more mentee devices are selected from the group consisting of mobile phone, laptop computer, tablet device, desktop computer and other electronic communication devices.

In an embodiment, the career mentoring system executes a method, the method includes:

A method for registration of the mentee in the mentee device through the mentee input unit, the method includes: The mentee selects mentee type, herein the mentee type is selected from the group is selected from a student mentee and a professional mentee; the mentee enters registration data into the mentee device; the mentee enters professional experience details in case of professional mentee into the mentee device; the mentee chooses career field and career sub field; the registration data of the mentee is transferred from the mentee device to the central server computer through internet; the registration data of the mentee is stored in the central database storage unit; the registration data of the mentee is processed by the central processing unit for validation; a one-time password code is generated by the central processing unit and sends to the mentee device for validation; the mentee device receives one-time password in form of electronic message notification; the one-time password code is entered into the mentee device through the mentee input unit for validation; the mentee is verified after successful one-time password code validation; the mentee completes process of registration; and the mentee receives notification on the mentee device in form of electronic message notification after registration.

A method for registration of the mentor in the mentor device through the mentor input unit, the method includes: The mentor enters registration data into the mentor device; the mentor enters professional experience details into the mentor device; the mentor chooses career field and career sub field; the mentor enters honors and awards details into the mentor device; the mentor enters bank details and KYC details into the mentor device; the registration data of the mentor is transferred from the mentor device to the central server computer through internet; the registration data of the mentor is stored in central database storage unit; the registration data of the mentor is processed by the central processing unit for validation; a one-time password code is generated by the central processing unit and sends to the mentor device for verification; the mentee device receives one-time password in form of electronic message notification; the one-time password code is entered into the mentor device through the mentor input unit for verification; the mentor is verified after successful one-time password code verification; and the mentor completes process of registration.

A method for validation of the mentor, the method includes: a monitoring team of the central server computer examines the registration data of the mentor and validates the mentor profile according to mentor panel guidelines; the central server computer activates profile of the mentor after validation; the mentor receives notification on the mentor device in form of electronic message notification after validation; the mentor is added to the mentor panel after validation; the mentor sets date and time slots for mentoring session according to availability into the mentor device.

A method of mentoring for the mentee, the method includes The mentee logs into the mentee device by the mentee input unit and selects career field and career sub field; the mentee selects mentor from the mentor panel according to career field and career sub field; the mentee selects a time slot for mentoring session for a particular mentor; the mentee enters session expectations by the mentee input unit for the mentor from the career sub field; the mentor approves the mentoring session through the mentor device; the mentee is informed after mentor approval by electronic message notification on the mentee device; the mentoring session is booked for the time slot; mentee has an option to edit the session expectations as per chosen career field and sub field to share his session expectations with mentor; the mentee proceeds for payment through the mentee device and mentoring session is scheduled after the payment; the mentee attends real time mentoring session by the mentor on a scheduled time slot through the mentee interaction unit; the mentee enters feedback after mentoring session by the mentee input unit into the mentee device; the mentoring session is done between mentor and mentee on real time basis through the mentee interaction unit and the mentor interaction unit.

A method of mentoring by the mentor, the method includes: the mentor logs into the mentor device by the mentee input unit; the mentor reviews and updates registration data through the mentor device; the mentor is notified about the mentoring session on the mentor device by the central server computer through notification in form of electronic message notification; the mentor approves the mentoring session into the mentor device by the mentor input unit; the mentor receives the mentee's profile, type and session expectations after approval through the mentor device; the mentor prepares for the mentoring session; the mentor provides real time mentoring session to the mentee on a scheduled time slot through the mentor interaction unit; the mentor enters feedback about the mentoring session by the mentor input unit into the mentor device.

Herein, the mentor reschedules the mentoring session into the mentor device by the mentor input unit. Herein, the mentor cancels the mentoring session into the mentor device by the mentor input unit and inputs the reason for cancellation. Herein, the mentee rebooks mentoring session with the same mentor or other mentor after cancellation of scheduled mentoring session. Herein, the mentee and the mentor are notified about approval, cancelling and rescheduling of mentoring session on the mentor device and the mentee device by the central server computer through notification in form of electronic message notification. Herein, the mentoring session is real time live interaction between the mentee and the mentor through the mentee interaction unit and the mentor interaction unit. Herein, the mentor shares articles, blogs and posts through the mentor device. Herein, the mentoring session is selected from video mode, audio mode and text mode through the mentee interaction unit and the mentor interaction unit. Herein, the mentoring sessions are recorded and saved by the central server computer into the central database storage unit. Herein, the central server computer provides ratings to the mentor according to feedback, experience, location and mentoring session mode. Herein, in an embodiment of the present invention, the mentee and the mentor take quarterly or annually subscription for mentoring sessions. Herein, in an embodiment of the present invention, parents of mentee access mentor profiles and receive session updates about mentoring sessions. Herein, the two mentors are able to interact with each through their own respective mentor interaction unit. Herein, the mentee is able to interact with more than one mentor at time using the mentee interaction unit. In an embodiment, the central server computer sends job notification to the mentee on the at least one mentee device by executing computer readable instructions on the central processing unit. In an embodiment, the central server computer create report card related of mentee and send to the mentee on the at least one mentee device by executing computer readable instructions on the central processing unit. In an embodiment, the central server computer provide gift session to the mentee on the at least one mentee device by executing computer readable instructions on the central processing unit.

In an embodiment, the career mentoring system executes a method, the method includes

A method for registration of the mentee in the one or more mentee devices through the mentee input unit, the method includes: The mentee selects mentee type, herein the mentee type is selected from the group is selected from a student mentee and a professional mentee; the mentee enters registration data into the one or more mentee devices; the mentee enters professional experience details in case of professional mentee into the one or more mentee devices; the mentee chooses one or more career fields and one or more career sub fields; the registration data of the mentee is transferred from the one or more mentee devices to the central server computer through internet; the registration data of the mentee is stored in the central database storage unit; the registration data of the mentee is processed by the central processing unit for validation; a one-time password code is generated by the central processing unit and sends to the one or more mentee devices for validation; the one or more mentee devices receive one-time password in form of electronic message notification; the one-time password code is entered into the one or more mentee devices through the mentee input unit for validation; the mentee is verified after successful one-time password code validation; the mentee completes process of registration; and the mentee receives notification on the one or more mentee devices in form of electronic message notification after registration.

A method for registration of the mentor in the one or more mentor devices through the mentor input unit, the method includes: the mentor enters registration data into the one or more mentor devices; the mentor enters professional experience details into the one or more mentor devices; the mentor chooses one or more career fields and one or more career sub fields; the mentor enters honors and awards details into the one or more mentor devices; the mentor enters bank details and KYC details into the one or more mentor devices; the registration data of the mentor is transferred from the one or more mentor devices to the central server computer through internet; the registration data of the mentor is stored in central database storage unit; the registration data of the mentor is processed by the central processing unit for validation; a one-time password code is generated by the central processing unit and sends to the one or more mentor devices for verification; the one or more mentor devices receives one-time password in form of electronic message notification; the one-time password code is entered into the one or more mentor devices through the mentor input unit for verification; the mentor is verified after successful one-time password code verification; and the mentor completes process of registration.

A method for validation of the mentor, the method includes: a monitoring team of the central server computer examines the registration data of the mentor and validates the mentor profile according to mentor panel guidelines; the central server computer activates profile of the mentor after validation; the mentor receives notification on the one or more mentor device in form of electronic message notification after validation; the mentor is added to the mentor panel after validation; the mentor sets date and time slots for mentoring session according to availability into the one or more mentor devices.

A method of mentoring for the mentee, the method includes: the mentee logs into the one or more mentee devices by the mentee input unit and selects one or more career fields and one or more career sub fields: the mentee selects mentor from the mentor panel according to one or more career fields and one or more career sub fields; the mentee selects a time slot for mentoring session for a particular mentor; the mentee enters session expectations by the mentee input unit for the mentor from the career sub field; the mentor approves the mentoring session through the one or more mentor devices; the mentee is informed after mentor approval by electronic message notification on the one or more mentee devices; the mentoring session is booked for the time slot; mentee has an option to edit the session expectations as per chosen career field and sub field to share his session expectations with mentor; the mentee proceeds for payment through the one or more mentee devices and mentoring session is scheduled after the payment; the mentee attends real time mentoring session by the mentor on a scheduled time slot through the mentee interaction unit; the mentee enters feedback after mentoring session by the mentee input unit into the one or more mentee devices; the mentoring session is done between mentor and mentee on real time basis through the mentee interaction unit and the mentor interaction unit.

A method of mentoring by the mentor, the method includes: the mentor logs into the one or more mentor devices by the mentee input unit; the mentor reviews and updates registration data through the one or more mentor devices; the mentor is notified about the mentoring session on one or more mentor devices by the central server computer through notification in form of electronic message notification; the mentor approves the mentoring session into the one or more mentor devices by the mentor input unit; the mentor receives the mentee's profile, type and session expectations after approval through the one or more mentor devices; the mentor prepares for the mentoring session; the mentor provides real time mentoring session to the mentee on a scheduled time slot through the mentor interaction unit; the mentor enters feedback about the mentoring session by the mentor input unit into the one or more mentor devices; the mentor reschedules the mentoring session into the one or more mentor devices by the mentor input unit; the mentor cancels the mentoring session into the one or more mentor devices by the mentor input unit and inputs the reason for cancellation; the mentee rebooks mentoring session with the same mentor or other mentor after cancellation of scheduled mentoring session; the mentee and the mentor are notified about approval, cancelling and rescheduling of mentoring session on the one or more mentor devices and the one or more mentee devices by the central server computer through notification in form of electronic message notification; the mentoring session is real time live interaction between the mentee and the mentor through the mentee interaction unit and the mentor interaction unit; the two mentor are able to interact with each through their own respective mentor interaction unit; and the mentee is able to interact more than one mentor at time using the mentee interaction unit. In an embodiment, the central server computer sends job notification to the mentee on the one or more mentee devices by executing computer readable instructions on the central processing unit. In an embodiment, the central server computer create report card related of mentee and send to the mentee on the one or more mentee device by executing computer readable instructions on the central processing unit. In an embodiment, the central server computer provide gift session to the mentee on the one or more mentee device by executing computer readable instructions on the central processing unit. Herein, the mentor shares articles, blogs and posts through the one or more mentor devices. Herein, the mentoring session is selected from video mode, audio mode and text mode through the mentee interaction unit and the mentor interaction unit. Herein, the mentoring sessions are recorded and saved by the central server computer into the central database storage unit. Herein, the central server computer provides ratings to the mentor according to feedback, experience, location and mentoring session mode. Herein, in an embodiment of the present invention, the mentee and the mentor take quarterly or annually subscription for mentoring sessions. Herein, in an embodiment of the present invention, parents of mentee access mentor profiles and receive session updates about mentoring sessions. Herein, the student mentee is selected from school student, graduate & post graduate. Herein, mentor and mentee can exchange document/study material via chat/text mode. Herein, the mentee can include Awards and honor in their mentee profile, they same will be shared to the mentor along with session details.

Further objectives, advantages and features of the present invention will become apparent from the detailed description provided herein below, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

I/We claim:

1. A career mentoring system (100), the career mentoring system (100) comprising:
a central server computer (102), the central server computer (102) having
a central database storage unit (104), the central database storage unit (104) stores mentor's and mentee's data, and
a central processing unit (106), the central processing unit (106) executes computer readable instructions for real time mentor-mentee interaction;
an at least one mentor device (108), the at least one mentor device (108) having
a mentor device processing unit (110),
a mentor database storage unit (112),
a mentor input unit (114), and
a mentor interaction unit (116);
an at least one mentee device (118), the at least one mentee device (118) having
a mentee device processing unit (120),
a mentee database storage unit (122),
a mentee input unit (124), and
a mentee interaction unit (126);
wherein, the central processing unit (106) of the central server computer (102) executes computer readable instructions of the career mentoring system (100) by communicating with the at least one mentor device (108) and the at least one mentee device (118), wherein, the at least one mentor device (108) and the at least one mentee device (118) are in two-way communication with the central server computer (102) through internet,
wherein, the mentor device processing unit (110) and the mentee device processing unit (120) execute computer readable instructions for mentor's and mentee's registration respectively, wherein, all data of mentor and mentee is stored in the central database storage unit (104) after registration,
wherein, the mentor input unit (114) and the mentee input unit (124) is used to input data and instruction from mentor and mentee to the at least one mentor device (108) and the at least one mentee device (118) respectively for registration and interaction between mentor and mentee,
wherein, the mentor interaction unit (116) and the mentee interaction unit (126) enable real time interaction between mentor and mentee through the at least one mentor device (108) and the at least one mentee device (118),
wherein, the mentor interaction unit (116) and the mentee interaction unit (126) work on video mode, audio mode and text mode for real time interaction between mentor and mentee through the at least one mentor device (108) and the at least one mentee device (118),
wherein, the mentor device processing unit (110) further executes computer readable instruction in order to help the mentor input unit (114) and the mentor interaction unit (116) to function and enable communication among mentor, mentee and the central server computer (102) by using a mentor input unit (114) and a mentor interaction unit (116), wherein, the mentee device processing unit (120) further executes computer readable instruction in order to help the mentee input unit (124) and the mentee interaction unit (126) to function and enable communication among mentor, mentee and the central server computer (102) by using the mentee input unit (124) and the mentee interaction unit (126), wherein, the mentor database storage unit (112) stores computer readable instruction that is being executed by mentor device processing unit (110) and further stores data input from the mentor input unit (114),
wherein, the mentee database storage unit (122) computer readable instruction that is being executed by the mentee device processing unit (120) and further stores data input from the mentee input unit (124)

2. The career mentoring system (100) as claimed in claim 1, wherein the central server computer (102) is enabled with artificial intelligence and improves the computer readable instructions that is being executed in the central processing unit (106).

3. The career mentoring system (100) as claimed in claim 1, wherein the career mentoring system (100) is used to organize individual mentoring, group mentoring and virtual conferences.

4. The career mentoring system (100) as claimed in claim 1, wherein the mentor is selected from the group consisting of industry expert, professor, experienced professional, alumni and subject matter expert.

5. The career mentoring system (100) as claimed in claim 1, wherein the at least one mentor device (108) and the at least one mentee device (118) are selected from the group consisting of mobile phone, laptop computer, tablet device, desktop computer and other electronic communication devices.

6. The career mentoring system (100) as claimed in claim 1, wherein the career mentoring system (100) executes a method, the method comprising:
a method for registration of the mentee in the at least one mentee device (118) through the mentee input unit (124), the method having
the mentee selects mentee type, wherein the mentee type is selected from the group is selected from a student mentee and a professional mentee,
the mentee enters registration data into the at least one mentee device (118),
the mentee enters professional experience details in case of professional mentee into the at least one mentee device (118),
the mentee chooses at least one career field and at least one career sub field,
wherein, the registration data of the mentee is transferred from the at least one mentee device (118) to the central server computer (102) through internet,
wherein, the registration data of the mentee is stored in the central database storage unit (104), wherein, the registration data of the mentee is processed by the central processing unit (106) for validation,
a one-time password code is generated by the central processing unit (106) and sends to the at least one mentee device (118) for validation,
the at least one mentee device (118) receives one-time password in form of electronic message notification,
the one-time password code is entered into the at least one mentee device (118) through the mentee input unit (124) for validation,
the mentee is verified after successful one-time password code validation, the mentee completes process of registration,
the mentee receives notification on the at least one mentee device (118) in form of electronic message notification after registration, and
wherein, mentor and mentee can exchange document/Study material via chat/text mode;
a method for registration of the mentor in the at least one mentor device (108) through the mentor input unit (114), the method having
the mentor enters registration data into the at least one mentor device (108),
the mentor enters professional experience details into the at least one mentor device (108),
the mentor chooses at least one career field and at least one career sub field,
the mentor enters honors and awards details into the at least one mentor device (108),
the mentor enters bank details and KYC details into the at least one mentor device (108),
wherein, the registration data of the mentor is transferred from the at least one mentor device (108) to the central server computer (102) through internet, wherein, the registration data of the mentor is stored in central database storage unit (104), wherein, the registration data of the mentor is processed by the central processing unit (106) for validation,
a one-time password code is generated by the central processing unit (106) and sends to the at least one mentor device (108) for verification,
the at least one mentor device (108) receives one-time password in form of electronic message notification,
the one-time password code is entered into the at least one mentor device (108) through the mentor input unit (114) for verification,
the mentor is verified after successful one-time password code verification,
the mentor completes process of registration,
a method for validation of the mentor, the method having
a monitoring team of the central server computer (102) examines the registration data of the mentor and validates the mentor profile according to mentor panel guidelines,
the central server computer (102) activates profile of the mentor after validation,
the mentor receives notification on the at least one mentor device (108) in form of electronic message notification after validation,
the mentor is added to the mentor panel after validation,
the mentor sets date and time slots for mentoring session according to availability into the at least one mentor device (108),
a method of mentoring for the mentee, the method having
the mentee logs into the at least one mentee device (118) by the mentee input unit (124) and selects at least one career field and at least one career sub field,
the mentee selects at least one mentor from the mentor panel according to at least one career field and at least one career sub field,
the mentee selects a time slot for mentoring session for a particular mentor,
the mentee enters session expectations by the mentee input unit (124) for the at least one mentor from the at least one career sub field,
the mentor approves the mentoring session through the at least one mentor device (108),
the mentee is informed after mentor approval by electronic message notification on the at least one mentee device (118),
the mentoring session is booked for the time slot,
the mentee proceeds for payment through the at least one mentee device (118) and mentoring session is scheduled after the payment,
the mentee attends real time mentoring session by the mentor on a scheduled time slot through the mentee interaction unit (126),
the mentee enters feedback after mentoring session by the mentee input unit (124) into the at least one mentee device (118),
wherein, mentee has an option to edit the session expectations as per chosen career field and sub field to share his session expectations with mentor, wherein,
the mentoring session is done between mentor and mentee on real time basis through the mentee interaction unit (126) and the mentor interaction unit (116);
a method of mentoring by the mentor, the method having
the mentor logs into the at least one mentor device (108) by the mentee input uni (114),
the mentor reviews and updates registration data through the at least one mentor device (108),
the mentor is notified about the mentoring session on the at least one mentor device (108) by the central server computer (102) through notification in form of electronic message notification,
the mentor approves the mentoring session into the at least one mentor device (108) by the mentor input unit (114),
the mentor receives the mentee's profile, type and session expectations after approval through the at least one mentor device (108),
the mentor prepares for the mentoring session,
the mentor provides real time mentoring session to the mentee on a scheduled time slot through the mentor interaction unit (116),
the mentor enters feedback about the mentoring session by the mentor input unit (114) into the at least one mentor device (108),
wherein, the mentor reschedules the mentoring session into the at least one mentor device (108) by the mentor input unit (114), wherein, the mentor cancels the mentoring session into the at least one mentor device (108) by the mentor input unit (114) and inputs the reason for cancellation, wherein, the mentee rebooks mentoring session with the same mentor or other mentor after cancellation of scheduled mentoring session, wherein, the mentee and the mentor are notified about approval, cancelling and rescheduling of mentoring session on the at least one mentor device (108) and the at least one mentee device (118) by the central server computer (102) through notification in form of electronic message notification, wherein, the mentoring session is real time live interaction between the mentee and the mentor through the mentee interaction unit (126) and the mentor interaction unit (116);
wherein, the student mentee is selected from school student, graduate & post graduate wherein, the mentor shares articles, blogs and posts through the at least one mentor device (108), wherein, the central server computer (102) provides ratings to the mentor according to feedback, experience, location and mentoring session mode, wherein, mentor and mentee can exchange document/Study material via chat/text mode,
wherein, the mentoring session is selected from video mode, audio mode and text mode through the mentee interaction unit (126) and the mentor interaction unit (116), wherein, the mentoring sessions are recorded and saved by the central server computer (102) into the central database storage unit (104), wherein, the mentee can include Awards and honor in their mentee profile, they same will be shared to the mentor along with session details, Wherein, the two mentor are able to interact with each through their own respective mentor interaction unit (116), wherein, the mentee is able to interact more than one mentor at time using the mentee interaction unit (126).

7. The method as claimed in claim 6, wherein, the central server computer (102) sends job notification to the mentee on the at least one mentee device (118) by executing computer readable instructions on the central processing unit (106).

8. The method as claimed in claim 6, wherein the central server computer (102) create report card related of mentee and send to the mentee on the at least one mentee device (118) by executing computer readable instructions on the central processing unit (106).

9. The method as claimed in claim 6, wherein the central server computer (102) provide gift session to the mentee on the at least one mentee device (118) by executing computer readable instructions on the central processing unit (106).
